(19) United States
(12) Patent Application Publication
(10) Pub. No.: US 2005/0068276 A1
(43) Pub. Date: Mar. 31, 2005

(54) Method for driving liquid crystal display devices

(76) Inventor: Jih-Shin Ho, Kaohsiung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/673,525

(22) Filed: Sep. 29, 2003

(51) Int. Cl. G09G 3/36

(52) U.S. Cl. 345/87

(57) ABSTRACT

A method for driving liquid crystal display devices is disclosed, and includes the steps: establishing a minimum voltage level (V5) to be base voltage; establishing the other voltage levels (V1˜V4) besides the base voltage from the high voltage level (V5); adjusting the established voltage levels to cause the voltage difference dV between adjacent voltage levels to maintain a constant dV, so as to satisfy the relationship: V5−V4=V4−V3=V2−V11=V1−V0=dV. Since the voltage levels V0˜V5 are set up on the basis of previously established voltage levels, if any established voltage values are changed, all subsequently established voltage values will be changed simultaneously to match the constant voltage difference (dV) between adjacent voltage levels.

### BACKGROUND OF THE INVENTION

1. Field of the Invention

The present invention relates to a method for driving liquid crystal display (LCD) devices, in particular to a method of generating symmetrical voltage signals to control with precision pixels displayed on a liquid crystal display (LCD) device.

2. Description of Related Arts With reference to FIGS. 11 and 12, pixels on an LCD device are arranged in columns and rows with specific column addresses (S0, S1, etc.) and row addresses (C0, C1, etc.). A particular pixel is activated by a voltage difference (dV) between a column control signal (COM) and a row control signal (SEG). The row control signal (SEG) in a conventional addressing technique does not just target a pixel at a particular address (C0, S0), but all the other pixels in the same row (S0) as well, because all the pixels in that row will receive the same row control signal.

With reference to FIG. 12, this problem is overcome by selectively applying four drive voltages (V0, V3, V4, V5) to the LCD display. The voltage level of the column control signal (COM) is switched between V0 and V4, and the voltage level of the row control signal (SEG) is switched between V3 and V5. When one column of pixels is selected, the voltage level of the column control signal (COM) is V0, and in the non-selection period, the voltage level is V4. The row control signal (SEG) is switched between V3 and V5 depending on whether the pixel status is 0 or 1. The maximum voltage level is V5. To improve the performance, the drive voltage is generally boosted far beyond the operation voltage.

In actual operation, when a row of pixels is selected, the voltage difference of the individual pixels in the row is either |V5−V0| or |V3−V0| depending on whether the pixel status is zero or one. In the non-selection period, the voltage difference of all the pixels is either |V5−V4| or |V3−V4|, which are the same (dV).

Since the performance of an LCD device is sensitive to DC bias voltage, the average voltage applied on each pixel has to be zero to remove the DC elements. To accomplish this, there needs to be six voltage levels, as shown in FIG. 13, for driving an LCD device. The voltage level of the column control signal (COM) has to be alternated between (V4, V0) and (V1, V5), and the row control signal (SEG) between (V3, V5) and (V2, V1), such that the average voltage value applied on each pixel can be kept at zero τVpixel=0, whilst the voltage difference for each pixel |Vpixel| remains unchanged. Therefore the above operation shall satisfy the following conditions to produce a constant dV value: V5−V4=V4−V3=V2−V1=V1−V0=dV.

A conventional method of applying six voltage levels is shown in FIG. 14. In this implementation, a plurality of series resistors is used for voltage division. The voltage levels are controlled by the resistance in the series resistors. Since this method of selecting the resistance value is not precise, in that case, the above-mentioned conditions cannot be achieved. The resistance value in a factory-produced resistor device is usually not precisely set, but rather with a tolerance margin. Normally, a substantial drive current is needed to offset noise disturbance in the circuit, which is a power-consuming method. If several voltage differences (dV) are needed on the same chip, it is necessary to hardwire resistors in different sections of the circuit manually. Therefore, the precision of the voltage settings is largely questionable during circuit action.

Another conventional way of generating voltage levels is shown in FIG. 15, by utilizing a voltage doubling circuit. This design is based on the assumption that V0=0, where both V1 and V2 are generated by the operation voltage (Vdd) and V2=2V1. The shortcoming is that V1 and V2 cannot be larger than the operation voltage (Vdd). A voltage doubling circuit, a multiple of the original input voltage (V1), generates the voltage levels (V2, V3, and V5). If the required voltage difference (dV) between V5 and V1 is other than a round number multiple, then the circuit modification can be very complicated. Furthermore, since V5 is the high voltage supplying the entire circuit, the current output of the circuit will be lessened most of the time, thus the above-mentioned conditions are not likely to be achieved.

### SUMMARY OF THE INVENTION

The main object of the present invention is to provide a method for driving liquid crystal display (LCD) devices, such that the drive voltage can be precisely set with a constant voltage difference (dV) for precision control of the pixel display on an LCD device.

The control technique calls for the creation of N+1 voltage levels (V0˜V_{N}), comprising the steps of:
defining a minimum voltage level serving as the base voltage (V0);
defining a maximum voltage level serving as the high voltage (V_{N});
defining all voltage levels to-be-established (V1˜V_{N-1}) other than the high voltage (V_{N}) and the base voltage (V₀);
establishing any voltage level among all voltage levels to-be-established (V₁˜V_{N-1}) basing on the high voltage (V_{N}), and then defining the new voltage level as an established voltage level;
establishing any voltage level still not established among voltage levels to-be-established (V₁˜V_{N-1}) basing on the base voltage (V0), high voltage (V_{N}), and all established voltage levels, and then defining the new voltage level as an established voltage level.

The present invention is characterized in that the established voltage is always used as a base voltage for establishing the next voltage among voltage levels to-be-established (V₁˜V_{N-1}).

The present invention is characterized in that the voltage difference dV between any two adjacent voltage levels is always a constant value, from the base voltage to the

$$\frac{N + 1}{2} - 1$$

th voltage level, and from

$$\frac{N + 1}{2}$$

th voltage level to the high voltage (V_{N}).

Since each voltage level is established from the immediately preceding voltage level, if any previously established voltage is changed, then all subsequently generated voltage levels will be affected by the change and adjusted accordingly, to maintain the constant voltage difference value dV between two adjacent voltage levels.

The features and structure of the present invention will be more clearly understood when taken in conjunction with the accompanying drawings.

### BRIEF DESCRIPTION OF THE DRAWINGS

FIG. 1 is a block diagram of the architecture of the first preferred embodiment of the present invention;

FIG. 2 is a diagram of the voltage levels used for controlling a pixel display in accordance with the present invention;

FIG. 3 is schematic diagram of the circuit implementation in the first embodiment;

FIG. 4 is the schematic diagram of the first stage circuit in the first embodiment;

FIG. 5 is the schematic diagram of the second stage circuit in the first embodiment;

FIG. 6 is the schematic diagram of the third and fourth stage circuits in the first embodiment;

FIG. 7 is a waveform diagram of the clock signals for controlling the level switching circuits shown in FIGS. 4˜6;

FIG. 8 is a diagram of the architecture of another embodiment of the invention;

FIG. 9 is a diagram of still another embodiment of the invention;

FIG. 10 is a diagram of still another embodiment of the invention;

FIG. 11 is the pixel arrangement on a conventional LCD device;

FIG. 12 is the diagram of the voltage levels used for controlling a conventional LCD device;

FIG. 13 is another diagram of the voltage levels used by a conventional technique;

FIG. 14 is the block diagram of the conventional circuit used to control voltage levels; and

FIG. 15 is the block diagram of another conventional circuit to control the voltage levels.

### DETAILED DESCRIPTION OF THE PREFERRED EMBODIMENT

The present invention provides a method for driving liquid crystal display (LCD) devices involving the generation of N+1 levels of drive voltage (V0˜V_{N}) for precision control of pixel display on a LCD device. This voltage control technique includes the steps of:
defining a minimum voltage level serving as a base voltage (V0);
defining a maximum voltage level serving as a high voltage (V_{N});
defining all voltage levels among voltage levels to-be-established (V₁˜V_{N-1}) other than the high voltage (V_{N}) and the base voltage (V0);
establishing any voltage level among voltage levels to-be-established (V₁˜V_{N-1}) basing on the high voltage (V_{N}), and then defining the new voltage level as an established voltage level;
establishing any voltage level still among voltage levels to-be-established (V₁˜V_{N-1}) basing on the base voltage (V0), the high voltage (V_{N}), and all previously established voltage levels, and then defining the new voltage level as an established voltage level; wherein,
the established voltage level is always used as the base voltage for establishing the next voltage in voltage levels to-be-established (V₁˜V_{N-1}).

The voltage difference dV between any two adjacent voltage levels is always a constant value, from the base voltage to the

$$\frac{N + 1}{2} - 1$$

th voltage level, and from

$$\frac{N + 1}{2}$$

th voltage level to the high voltage (V_{N}).

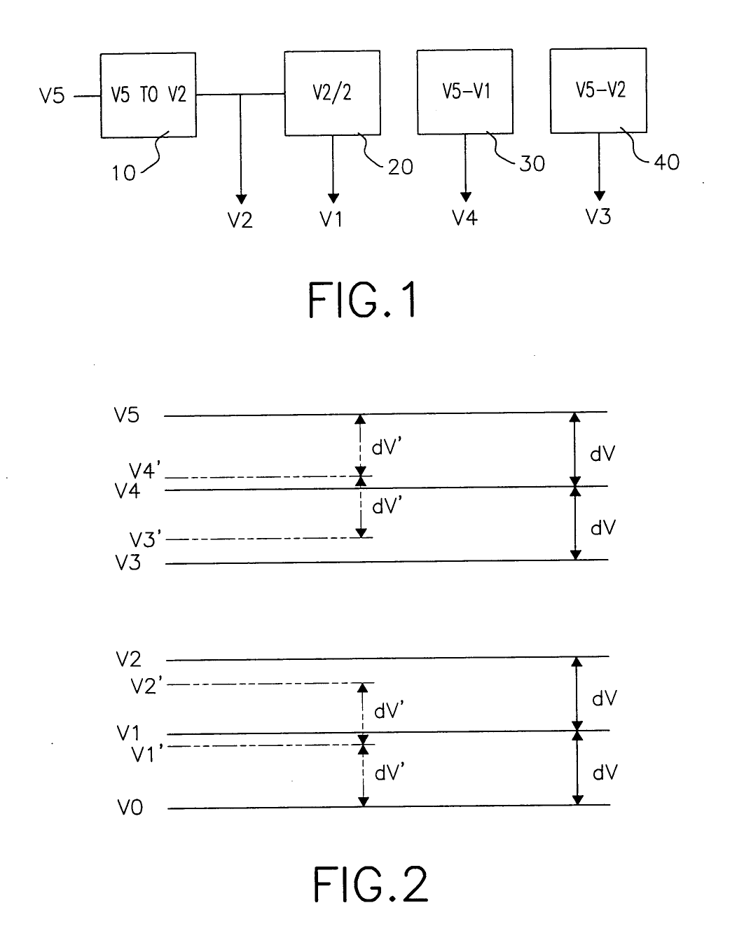

To illustrate with an actual example, the basic hardware for the first preferred embodiment, as shown in FIG. 1, incorporates a first stage circuit (10) as a division circuit, a second stage circuit (20) as a division circuit, a third stage circuit (30) as a subtraction circuit, and a fourth stage circuit (40) as a subtraction circuit. Six voltage levels (V0˜V5), N+1=6, are defined for the drive voltage, as depicted in FIG. 2.

For simplicity in the present discussion, the base voltage (V0) is assumed to be zero value. The main point is that each voltage level is related to any other among the six voltage levels (V0˜V5). Therefore if any voltage is changed, then all other voltage levels have to be changed, so as to maintain the constant dV between any adjacent voltage levels (V0˜V5).

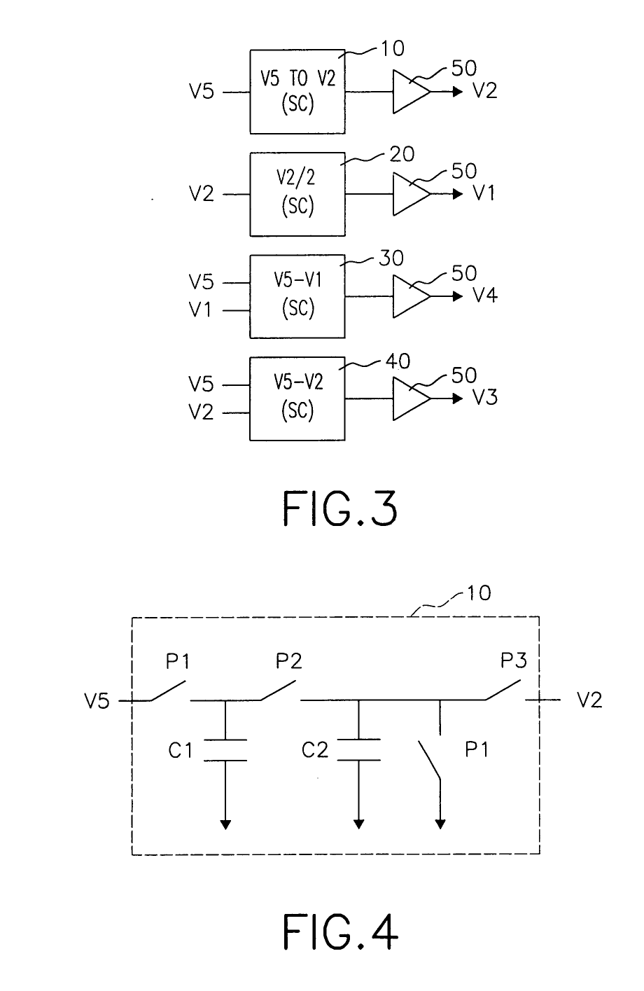

The generation of all six voltage levels is shown in FIG. 3. The high voltage (V5) is first input into the first stage circuit (10) to generate a second voltage (V2), and then the second voltage (V2) is input into the second stage circuit (20) (a division circuit), dividing by two, to obtain the first voltage (V1), and then the fourth voltage (V4) and the third voltage (V3) are respectively derived from preceding voltages through the third and fourth stage circuits (30, 40).

The fourth voltage (V4) is generated through the third stage circuit (30), by subtracting the first voltage (V₁) from the high voltage (V5); the third voltage (V3) is generated through the fourth stage circuit (40), by subtracting the second voltage (V2) from the high voltage (V5). However, the voltage difference (dV) between the second voltage (V2) and the third voltage (V3) is adjustable.

From the above description, it is apparent that the generation of voltage levels follows this sequence: V3/2 V1 V4 V3. If any established voltage level (for example, V2 or V1) is changed, all voltage levels derived therefrom (for example, V4 or V3) have to be changed to maintain the constant voltage difference (dV).

The original implementation shown FIG. 1 can be changed by capacitor switching to create the first to fourth stage circuits (10˜40), as implemented in the second preferred embodiment in FIG. 3. The outputs of the first to fourth stage circuits (10˜40) are connected to a buffer (50) to boost the driving capability of the output voltage. The main advantage of using capacitor switching is the realization of power saving.

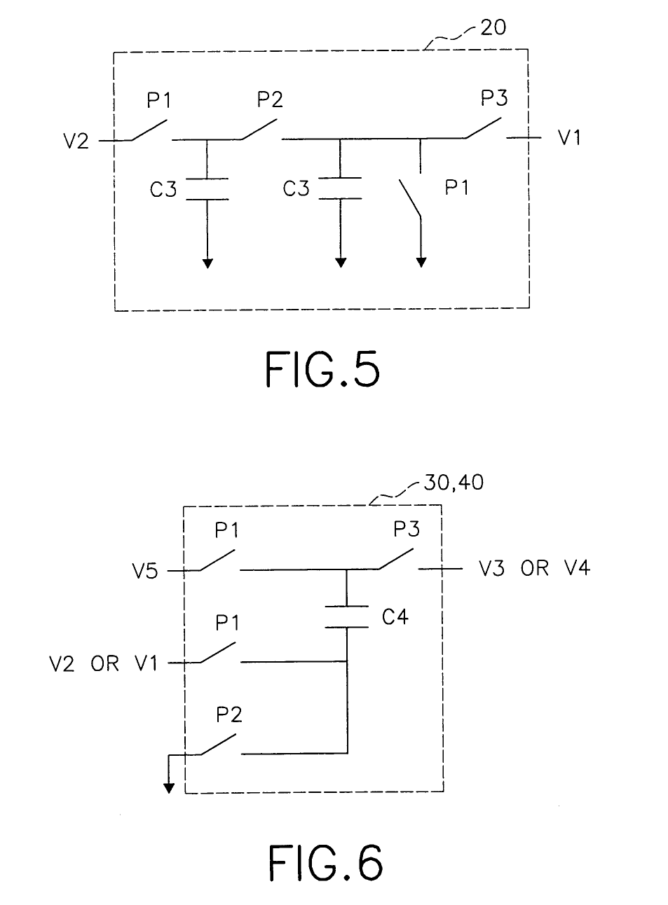

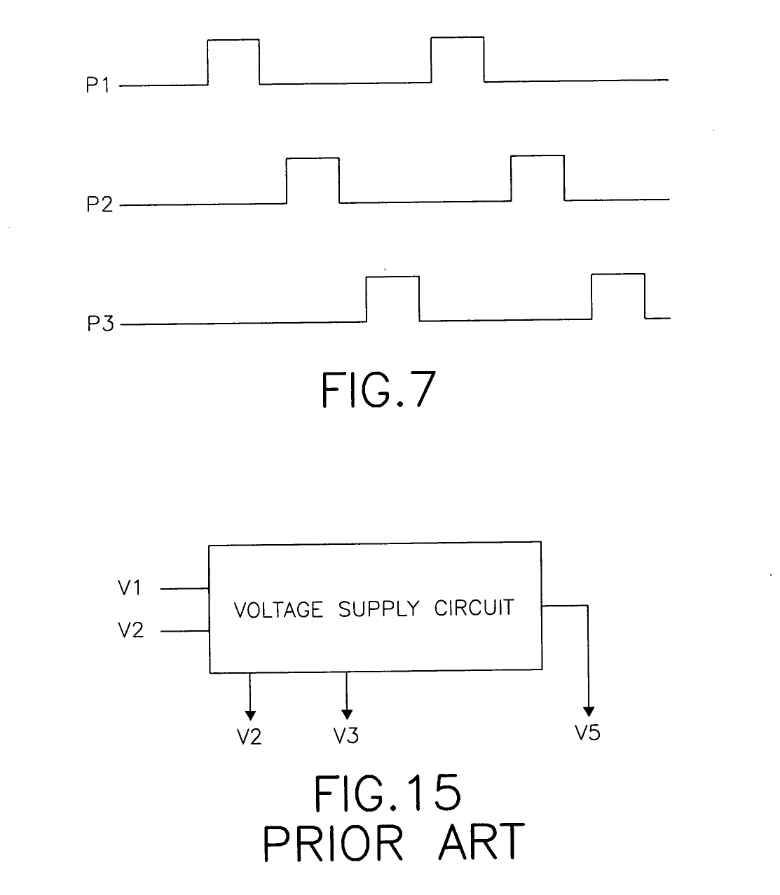

The architecture of the first to fourth stage circuits (10˜40) is shown in FIGS. 4˜6, wherein the third and fourth stage circuits (30) are identical to those used in the previous example, other than that the input voltage in this case becomes the first voltage (V1) or the second voltage (V2), and a switch is used for switching among the first to fourth stage circuits (10˜40), individually controlled by clock signals (P1˜P3) as shown in FIG. 7. The first stage circuit, in FIG. 4, is a division circuit. The output of the second voltage (V2) can be expressed as V2=V5×C1/(C1+C2). The circuit shown in FIG. 5 is also a division circuit, but two capacitors of equal capacitance act as a divide-by-two circuit to generate the first voltage (V1), which can be expressed as V1=V2/2=V2×C3/(C3+C3). The circuit shown in FIG. 6 is a subtraction circuit, generating the third voltage (V3), which can be expressed as V3=V5−V2 or V4=V5−V1.

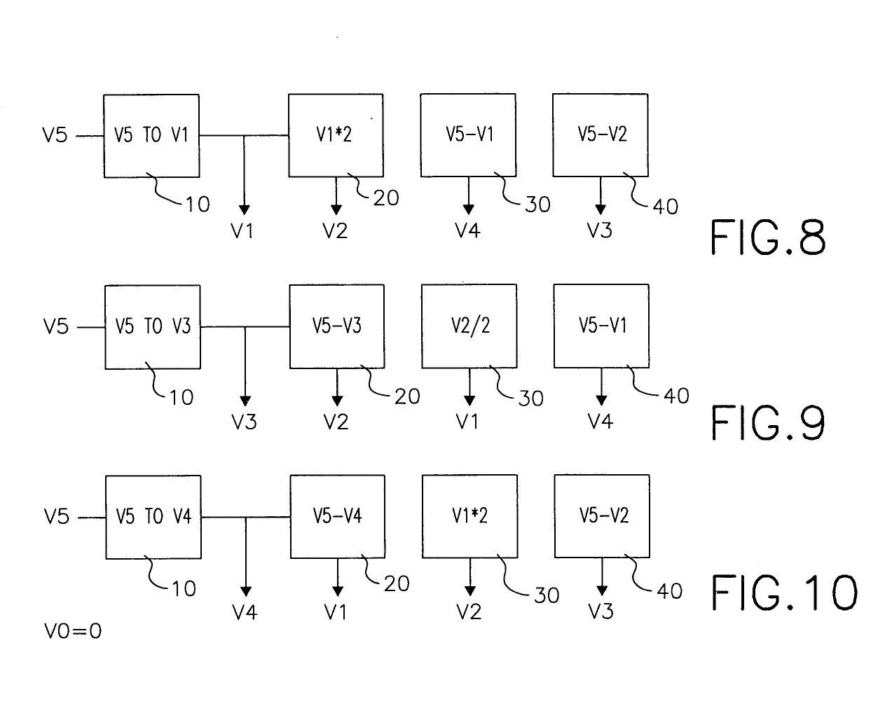

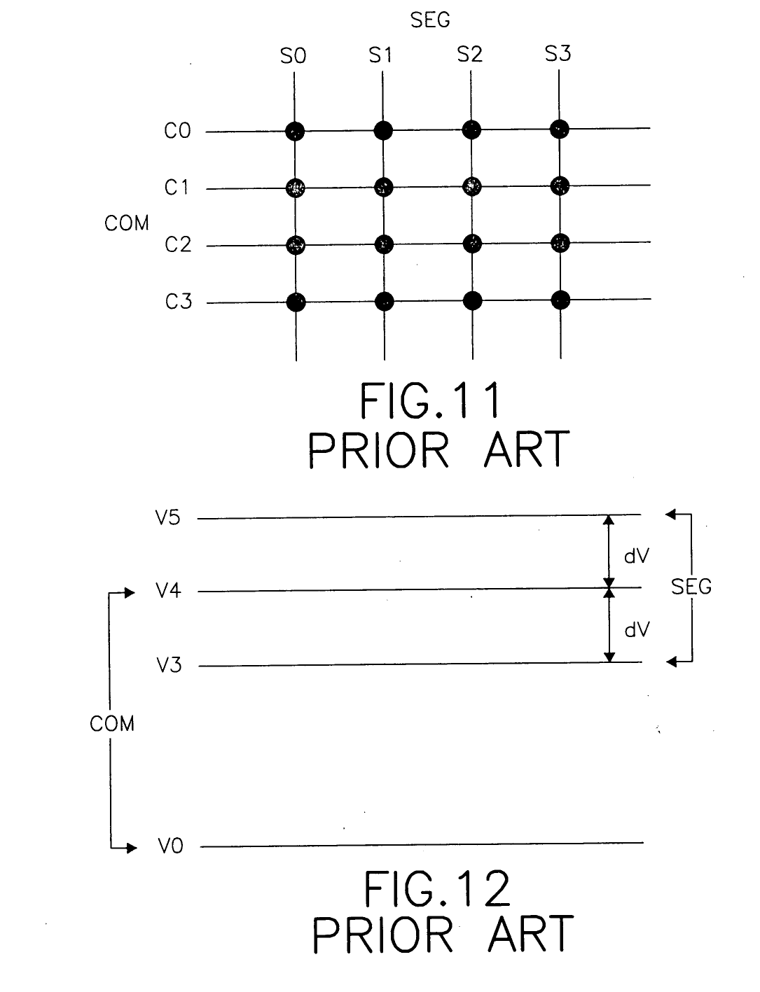

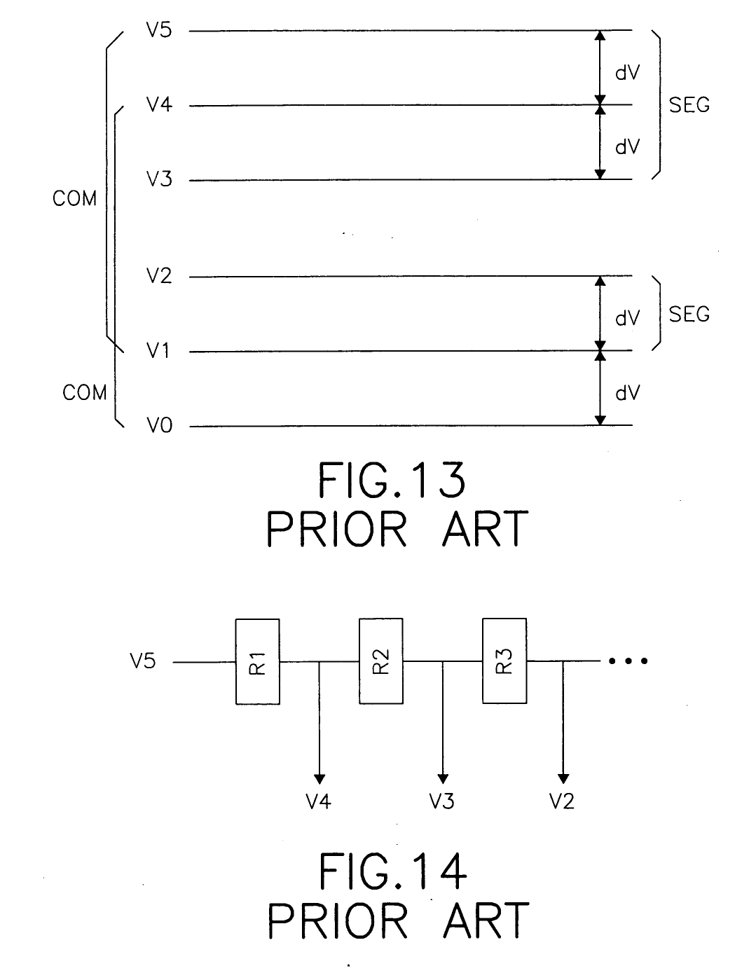

Three more variations of the present invention are shown in FIGS. 8-10. In each case, the first stage circuit (10) still uses the high voltage (V5) as an input for generating the first, third and fourth voltages (V1, V3, and V4). The second, third and fourth stage circuits (20˜40), in working with the first stage circuit (10), can be set up as a multiplication circuit, a division circuit and a subtraction circuit.

If the high voltage (V5) and the base voltage (V0) are fixed values, the value of voltage difference (dV) has to be changed to dV′ for reasons of controlling the drive voltage, and it is only necessary to change the first stage circuit (10) to have all voltage levels readjusted again for normal operation.

Using the first embodiment in FIG. 1 as an example, if the output voltage of the second stage circuit (20) is V2′, and V0=0, the first voltage (V1′) is exactly half of the second voltage (V2′). Therefore, the second stage circuit (20) is still a divide-by-two circuit, to generate a new first voltage V1′ that is only half of the new second voltage V2′. The voltage difference between the new first voltage V1′ and the base voltage V0 is set to be dV′, and the new third and fourth voltages (V4′, V3′) are to be derived from the new first and second voltages (V1′, V2′), and the voltage differences are changed to dV′.

This method of changing the first stage circuit (10) is not only applicable to the first embodiment, but also to the other three embodiments shown in FIGS. 8˜10.

In summary, the method for driving liquid crystal display devices is to use the voltage level of an existing voltage level as the base voltage and all other voltage levels are to be derived therefrom. If any established voltage is changed, then all subsequently established voltage levels also have to be changed to maintain the constant voltage difference value (dV). If for reasons of controlling the drive voltage, the voltage difference (dV) is changed, it is only necessary to modify the first stage circuit, so that all following circuits will be changed simultaneously to match the new dV.

The foregoing description of the preferred embodiments of the present invention is intended to be illustrative only and, under no circumstances, should the scope of the present invention be so restricted.

1. A method for driving liquid crystal display devices involving the generation of N+1 levels of output voltage (V₀˜V_{N}), comprising the steps of:
defining a minimum voltage as base voltage (V₀);
defining a maximum voltage as high voltage (V_{N});
defining all voltage levels among voltage levels to-be-established V₁˜V_{N-1}) other than the base voltage (V₀) and the high voltage (V_{N});
generating any voltage level among voltage levels to-be-established (V₁˜V_{N-1}) basing on using the high voltage (V_{N}), and then defining a new voltage as an established voltage level;
generating any voltage level among voltage levels to-be-established (V₁˜V_{N-1}) basing on the base voltage (V₀), the high voltage (V_{N}), and all previously established voltage levels, and then defining the new voltage as an established voltage level;
wherein,
the established voltage level is always used as the base voltage for establishing the next voltage in voltage levels to-be-established (V₁˜V_{N-1});
the voltage difference dV between any two adjacent voltage levels is always a constant value, from the base voltage to the
$$\frac{N + 1}{2} - 1$$
th voltage level, and from
$$\frac{N + 1}{2}$$
th voltage level to the high voltage (V_{N}).

2. The method for driving liquid crystal display devices as claimed in claim 1, wherein all the established voltage levels are totaled up to six (N+1=6); the voltage levels V0˜V5 are arranged in order from the lowest to the highest; and the voltage difference dV between any two adjacent voltage levels shall satisfy the conditions: V5−V4=V4−V3=V2−V1=V1−V0=dV.

3. The method for driving liquid crystal display devices as claimed in claim 2, wherein when the base voltage (V0) has a zero value:
the second voltage (V2) is obtained from the high voltage (V5);
the first voltage (V1) is obtained by having the second voltage (V2) divided by two;
the fourth voltage (V4) is obtained by having the high voltage (V5) subtracted by the first voltage (V1); and
the third voltage (V3) is obtained by having the high voltage (V5) subtracted by the second voltage (V2).

4. The method for driving liquid crystal display devices as claimed in claim 2, wherein when the base voltage (V0) has a zero value:
the first voltage (V1) is obtained from the high voltage (V5);
the second voltage (V2) is obtained by having the first voltage (V1) multiplied by two;
the fourth voltage (V4) is obtained by having the high voltage (V5) subtracted by the first voltage (V1); and
the third voltage (V3) is obtained by having the high voltage (V5) subtracted by the second voltage (V2).

5. The method for driving liquid crystal display devices as claimed in claim 2, wherein when the base voltage (V0) has a zero value:
the third voltage (V3) is obtained from the high voltage (V5);
the second voltage (V2) is obtained by having the high voltage (V5) subtracted by the third voltage (V3);
the first voltage (V1) is obtained by having the second voltage (V2) divided by two; and
the fourth voltage (V4) is obtained by having the high voltage (V5) subtracted by the first voltage (V1).

6. The method for driving liquid crystal display devices as claimed in claim 2, wherein when the base voltage (V0) has a zero value:
the fourth voltage (V4) is obtained from the high voltage (V5);
the first voltage (V1) is obtained by having the high voltage (V5) subtracted by the fourth voltage (V4);
the second voltage (V2) is obtained by having the first voltage (V1) multiplied by two; and
the first voltage (V1) is obtained by having the high voltage (V5) subtracted by the second voltage (V2).
